(19) United States
(12) Patent Application Publication
(10) Pub. No.: US 2010/0306696 A1
(43) Pub. Date: Dec. 2, 2010

(54) DYNAMIC NETWORK BROWSER

(75) Inventors: Rasmus GROTH, Copenhagen NV (DK); Asbjoern Sloth Toennesen, Broenshoej (DK); Manolo Oliver Folcarelli, Copenhagen V (DK); Jonah Tesch Hallberg, Copenhagen N (DK); Joshua Sills Gottdenker, Copenhagen S (DK); Tor Kristensen, Copenhagen NV (DK); Clifford Lee Hall, Jonesborough, TN (US)

Correspondence Address: LOWE HAUPTMAN HAM & BERNER, LLP, 1700 DIAGONAL ROAD, SUITE 300, ALEXANDRIA, VA, 22314, US

(73) Assignee: LILA APS (AHEAD.), Copenhagen N (DK)

(21) Appl. No.: 12/626,869

(22) Filed: Nov. 27, 2009

Related U.S. Application Data
(60) Provisional application No. 61/118,121, filed on Nov. 26, 2008.

(51) Int. Cl. G06F 3/048

(52) U.S. Cl. 715/800; 715/854

(57) ABSTRACT

A system and method of browsing digital content, and is related to companion applications filed simultaneously, all of which are part and parcel of a method for browsing digital content and composing digital media and data, via dynamic interaction of tiled images, external video, audio, text, and multimedia resources to create smoother and faster response time to user request, managed by a level of detail system which expands the ability of the user to create, manipulate, and interact with digital content and media via an application hosted in a browser or running on a desktop application which enhances user ability to dynamically position and zoom into and out of views within a larger canvas.

### RELATED APPLICATIONS

The instant application is related to and claims priority from U.S. Provisional Application 61/118,121, filed Nov. 26, 2008, titled “Content-Context Browser” and is also related to application titled, “Dynamic Level of Detail (LoD)” and application titled, “Dynamic Image Tiling,” each filed on the same date, to the same inventors, and all of which are hereby incorporated by reference herein in their entirety.

### BACKGROUND

One or more embodiments of the present invention relates to a system and method of browsing digital content, and is related to companion applications filed simultaneously, all of which are part and parcel of a method for browsing digital content and composing digital media and data, via dynamic interaction of tiled images, external video, audio, text, and multimedia resources to create smoother and faster response time to user request, managed by a level of detail system which expands the ability of the user to create, manipulate, and interact with digital content and media via an application hosted in a browser or running on a desktop application which enhances user ability to dynamically position and zoom into and out of views within a larger canvas.

Internet browsers like Firefox and Microsoft (MS) Internet Explorer, image collection tools like Picasa, and presentation software like MS PowerPoint are all examples of well known tools for browsing digital content. Users browsing digital content by use of a computer system are limited to the information presented, in that the digital content is presented in only two dimensions. If the digital content does not fit in the screen, the screen only shows a section of the content of, for instance, a web page, and the content of the page can be moved around, such as by vertically and/or horizontally scrolling the content inside the web page.

When the entire web page is shown in a small screen display, the physical size and the resolution of the screen prevents a user from seeing or reading the content of the web page. Thus, small size displays, such as screens on mobile devices, are known to enable zooming inside a web page to enlarge parts of the page enabling details to be viewable. In doing so, the user enlarges sub-sections of the web page. The whole page may be viewed only by zooming into various segments inside the web page, just like using a magnifying glass to enhance details.

Use of zoom is also common in graphics software to enhance and work with details in digital images, for example, and to present an overview of the images. One example is Picasa, wherein contents of image albums are displayed using thumbnails of the images. The user can define and vary zoom levels, or the degree of expansion of viewable content. Use of zoom is also common in e-book and e-paper readers which allow digital versions of books and papers to be viewed on computer screens. In some applications, the pages can be virtually “turned” and sequential content viewed and read by zooming in on sections of a selected page in the book or newspaper, e.g., as demonstrated at the web addresses pageflip.hu/free.php or issuu.com. Seadragon, available from Microsoft Corporation of Redmond, Wash., is one such example like digital versions of newspapers. Seadragon provides smooth, seamless browsing of vast quantities of visual information, whether on wall sized displays or mobile devices, and regardless of the amount of data. Another example is the Times reader available from The New York Times.

A zoom effect is also provided by a program entitled DeepZoom, enabled in the web application framework called Silverlight available from Microsoft. DeepZoom allows users to zoom into or out of an image or a collage of images with smooth transitions by using a device such as a mouse wheel. The images can scale from 2 or 3 megapixels in resolution into the gigapixel range. A disadvantage of some such programs is that the user must wait for the download of an entire image before the image is available for viewing. In contrast, Silverlight downloads only the area in view, optimized for the zoom level being viewed. This feature of downloading only the area in view is also known from other executable software, e.g., GoogleEarth available from Google.

While the use of existing zoom technology known to the inventors can provide an extra dimension when browsing digital content by submerging information within content which is viewable when enlarged, one limitation of the current technology, for example in DeepZoom, is that to be able to obtain the deep zoom effect for a collage of images, the Silverlight application aligns adjacent images to “build” and create one new image. These types of technology provide the user with the impression of zooming in on the original collage of images. However, the images are just passive, not dynamic. Thus, DeepZoom does not provide an effective way of utilizing the depth provided by true zooming, such as with optical zoom technology.

### SUMMARY

An object of one or more embodiments of the invention is to introduce a dynamic zoom and/or pan functionality in digital content.

In at least some embodiments, this is achieved by a method for collecting, displaying, browsing, addressing, viewing, arranging, presenting and/or managing digital content in a frame on at least one screen, wherein the digital content comprises a plurality of virtual layers of the frame corresponding to a plurality of zoom levels of the frame, the frame comprises at least one space, a space being a subset of the frame and comprising at least a part of the digital content, browsing the digital content by zooming in and/or out within the frame and at least one space, thereby enlarging and/or shrinking, the space(s), and at least a part of the digital content.

In at least some embodiments, at least one space is represented by an icon on the frame when the frame is shrunk to a predefined size.

Thus, in accordance with one or more embodiments of the invention, a functionality is described for utilizing the added dimension of depth provided by zooming.

One embodiment of the invention provides an alternative and/or a supplement to applications, i.e., a set of executable or interpretable instructions, such as web browsers. In a traditional hypertext markup language-based (HTML) web browser, different web pages are accessible by hyperlinks and uniform resource locators (URL). Typically, digital content from only one web page is viewed at a time. Other web pages can be accessed and viewed by use of hyperlinks from the current web page or manually entering a new URL. In at least one embodiment of the invention, functionality is provided for collecting, structuring, presenting, addressing, viewing, browsing, adding, managing, zooming, panning, and/or displaying digital content in only one frame on a screen, on a digital canvas of vastly extensive viewing options on the screen, such as a monitor, e.g., a computer monitor, or a collection of monitors. The information is presented in two dimensions on, for example, the computer screen, but the depth of information that is stored and accessible for viewing becomes a third dimension. In at least some embodiments, vast amounts of information are collected within just one frame, or canvas, and accessed and viewed by users navigating and/or zooming inside the canvas.

The digital canvas thus provides a big “sea” of digital information wherein users can “dive” to access and view the information. Information is viewed when the user is close enough, that is to say, sufficiently zoomed in to a level where the content is viewable in detail.

In at least some embodiments, zooming inside the frame corresponds to moving through a plurality of virtual layers of the frame. In other words, a layer is associated to a zoom level. In at least some embodiments, there is a one-to-one correspondence between the layer and the zoom level. Associating digital content to each layer and/or level of zoom allows for a nearly infinite density of information to be contained by one or more spaces, and for that information to be presented to the screen without significant occlusion and deleterious visual interference from nearby content and/or spaces. A computer screen for example, can be thought of as based on a two dimensional Cartesian coordinate system. In order to present vast amounts of content, that content needed to be spread out over a wide two dimensional (2D) area in prior approaches. A plurality of zoom levels involves an additional z-coordinate thereby providing a third dimension (3D) to the coordinate system. A new or different x, y screen is viewed for a particular value of z. Each z value represents a different zoom level, which is also described as a virtual layer, or layer. Thereby, digital content is structured and presented on a much smaller area than what is possible in 2D structures, because content is placed and easily accessed on top and below of each other.

A further object of an embodiment of the invention is to calculate the center of the zoom movement from the location of the pointing device marker in the frame, such as by manipulating the scroll wheel of a mouse cursor. Often the center of zoom movement is the center of a screen or picture, such as in the lens of a camera. Having the center of zoom at the position of the pointing device marker is a way of zooming and also moving (translating the view) around within the frame by use of a single interaction. If the mouse cursor is at the top left corner of the frame, zooming will enlarge the top left corner of the frame thereby moving, i.e., shifting, translating, or otherwise modifying, the viewing position (the x,y coordinates) in the frame.

Browsing the digital content in the virtual layers is provided by zooming in and/or out inside the frame at any vector, thereby enlarging and/or shrinking, respectively, the digital content displayed to the user.

Having a vast amount of digital content in a frame can be difficult to manage, even if the content is arranged in different layers of the frame. Therefore, the frame, according to an embodiment of the invention comprises at least one space, in a possible plurality of spaces. A space is typically a collection of digital content. A space can be a sub-frame, ie. a subset of the frame. In at least some embodiments, a space is also defined as comprising certain digital content, i.e., part of the digital content of the frame. In at least some embodiments, a space belongs to a certain zoom level of the frame. In at least some embodiments, a space is also part of another space, i.e. a sub-space of a space. By grouping the digital content in spaces, the frame is made more orderly.

In at least some embodiments, a space is the analogue of a website in a web browser, such as a company's entire website comprised of the homepage and multiple single associated web pages. However, in at least some other embodiments, a space is also the analogue of just a single web page with a corresponding top level URL.

In accordance with at least one embodiment of the invention, content within a space and the space itself changes appearance in the frame when zoomed to a certain, i.e., predetermined, level. When examining the content of a space, the zoom level of the frame is suitable for viewing the content of the space. When zooming out of the space, the content shrinks. At a zoom out level where this content becomes too small to be perceived by the user, the content eventually turns into a small dot in the frame and seems to disappear from the user's view. Because small dots in the frame are not useful, i.e., providing no indication of what the dot represents or what is inside the dot, one or more embodiments of the invention provide the option that when zooming out of a space, at some point the content or the space itself is seamlessly transformed into an icon representing the content, or representing the space and content in the frame. In accordance with at least some embodiments, the icon is any representation, but in at least one embodiment the icon represents the context of the content or space. In other words, reducing to a certain zoom level or interval of zoom levels within a space, the content of a space becomes represented by an icon which is a symbol of the context of the space.

In at least one embodiment, the frame contains a number of overlaid canvases, each of which may contain content. The bottommost canvas can display a solid background color which is visible behind any non-obscuring content.

In at least one embodiment, at least a part of the digital content is editable and/or movable in the frame. Furthermore, digital content added to the frame and/or at least one space, and at any zoom level in at least one embodiment. Thereby a user can edit, add to and/or move the content around inside the frame and/or a space. Preferably, a user can also transfer content between different virtual layers by moving content between different zoom levels.

In at least some embodiments, sorting, structuring and arranging the digital content in the frame is further enhanced by the concept of “scenes”. In one embodiment of the invention, a scene is a predefined or user defined fixed view of a part of a space, i.e. a subset of the frame with a predetermined, i.e., predefined or user-defined, position. The predetermined position is defined with x, y, and z coordinates and a specified rotation in the frame, accessibility to the plurality of layers, or z coordinates, opening a plurality possibilities for what is displayed on the user's screen. Specific views or rotations are defined by introducing scenes. In at least some embodiments, a scene is part of a slideshow of scenes. In at least some other embodiments, a scene triggers interactive content inside the scene, like queuing a movie to start playing. In at least some other embodiments, a scene is part of one or more other scenes. In at least some other embodiments, a scene is a part of a space.

Furthermore, in at least one embodiment of the invention, a scene is added to the frame and/or to a space, for example, by a user, allowing the user to define the scene. One or more embodiments of the invention provide that a user directly “hyperlinks” to a scene with the creation of a shortcut (e.g. an URL) to a scene by use of a virtual button displayed on the screen which points to a digital location. Activating or manipulating the button corresponding to a scene navigates the user to the position and zoom level of the frame associated with said scene. In at least some embodiments, the navigation of the user to the position and/or zoom level of the frame occurs automatically. This makes it possible to link directly to a scene within a space from any web browser or other application supporting hypertext transport protocol (HTTP) URL hyperlinking.

In one embodiment of the invention, a project is a way of collecting and arranging spaces. A project comprises at least one space, such as a plurality of spaces.

Zooming in the frame is a capability of at least one embodiment of the invention. The zoom level of the frame is variable, such as from 0 to 100%, 0 to 100000%, and such as from 0 to 1000000%, ad infinitum.

In at least some embodiments, zooming inside the frame is performed in response to manipulation of a pointing device, such as by engaging the scroll wheel of a mouse. In at least one embodiment, the center of the zoom is provided at the location of the pointing device marker in the frame, for example, the mouse cursor in the frame. Thus, as the user moves the mouse cursor around in the screen while zooming the center of the zoom is dynamic, and moves to the position of the mouse cursor. Often the center of zooming, such as in the lens on a camera, is fixed in the center of the picture. Thus, if the mouse cursor is at the top left corner of the frame, zooming enlarges the top left corner of the frame thereby moving the viewing position, i.e. the (x, y) coordinates, in the frame.

The digital content can be images, movies, text, web pages, URL, graphics, animations, audio, PDF and/or the like.

The digital content is located and/or stored on the internet in, at least one database and/or a local storage medium. Thereby content in the frame is provided through a network such as the internet and/or a LAN. Thus, an analogy is that the frame represents the internet, or at least a part of the content of the internet. Another analogy is that the frame represents an intranet, or at least a part of an intranet.

In at least one embodiment of the invention, the document object model (DOM) is stored at one or more servers.

In at least one embodiment of the invention, the application is embedded in a web browser and executed in a Flash player also embedded in the browser.

### DEFINITIONS

### Term List

Frame—A named, 2-dimensional digital virtual canvas of potentially infinite Extent within which digital content (media items such as images, movies and animations) is placed in a predetermined arrangement, e.g., a preset arrangement, an arrangement the user desires, etc. A frame can be seen as the equivalent of an infinitely large table or whiteboard whereon content can be placed and manipulated freely, for example by use of a pointing device.
Extent—The smallest rectangular region that bounds content arranged and presented within a frame, i.e., the area of the virtual canvas that includes content.
Space—a subset of a frame.
Scene—A named, finite rectangular area within the coordinate system of a Space. A view port of fixed size that relates to the viewable area of the frame on a physical display screen.
Project—A collection of one or more spaces, media, metadata, and user permission settings accessible by one or more users.
Network Browser—a navigable network of visually connected nodes representing relations (permission, contextual) between spaces, projects, and users. The level of detail available in the Network Browser is dependent on the level of access and permissions assigned to the active user account.
Space Client—A multi-user software environment allowing users to singly or collaboratively view or modify the contents of a space, and create or navigate from scene to scene within a space.
Node—An iconic representation of a space, project or user displayed within the Network Browser.
Application—A computer software program comprising a set of executable or interpretable instructions for execution or interpretation by a processor.
Modular Application—An application whose functionality is distributed across a set of applications.
API—Application Programming Interface—A documented way for developers to write software that works with a given application.
Client—An application which runs on a user's computer and occasionally communicates with one or more servers or other clients via an internet connection.
Server—An application that responds to requests from individual clients, occasionally interacting with a database to store and retrieve information on behalf of the client. A server application may also facilitate the communications between clients.
Module—A unit of executable code that can be loaded dynamically at runtime, that is to say, during the period of time a software program is executing. The module can communicate with other modules and the shell that loads it.
Shell—A client which dynamically loads modules at runtime and facilitates their communications with each other.
Lila Client API—Lila's library which provides the API for its unique modular application development platform.
LilaClient—A special shell which is based upon the LilaClientAPI, and connects loaded modules so that they may collaborate to carry out the modular application's responsibilities.

Flash Player

The Adobe Flash Player is a widely distributed proprietary multimedia and application player created by Macromedia and now developed and distributed by Adobe. Flash Player runs shockwave flash (SWF) files that can be created by the Adobe Flash authoring tool, by Adobe Flex or by a number of other Macromedia and third party tools.

Adobe Flash, or simply Flash, refers to both a multimedia authoring program and the Adobe Flash Player, written and distributed by Adobe, that uses vector and raster graphics, a native scripting language called ActionScript and bidirectional streaming of video and audio. Strictly speaking, Adobe Flash is the authoring environment and Flash Player is the virtual machine used to run the Flash files. In colloquial language, Adobe Flash and Flash Player have become mixed: “Flash” can mean either the authoring environment, the player, or the application files.

Flash Player has support for an embedded scripting language called ActionScript (AS), which is based on ECMAScript. Since its inception, ActionScript has matured from a script syntax without variables to one that supports object-oriented code, and may now be compared in capability to JavaScript, another ECMAScript-based scripting language.

The Flash Player was originally designed to display 2-dimensional vector animation, but has since become suitable for creating rich Internet applications and streaming video and audio. It uses vector graphics to minimize file size and create files that save bandwidth and loading time. Flash is a common format for games, animations, and graphical user interfaces (GUIs) embedded into web pages.

The Flash Player is built into some browsers and is available as a plugin for recent versions of other browsers such as Mozilla Firefox, Opera, Safari and Internet Explorer on selected platforms. Each version of the plugin is completely backwards-compatible.

The Document Object Model

The Document Object Model (DOM) is a platform- and language-independent standard object model for representing HTML or extensible markup language (XML) and related formats. A web browser is not obliged to use the DOM in order to render an HTML document. However, the DOM is required by JavaScript scripts that wish to inspect or modify a web page dynamically. In other words, the DOM is the way JavaScript sees and renders its containing HTML page and browser state.

ECMAScript/JavaScript

ECMAScript is a scripting language, standardized by Ecma International in the ECMA262 specification. The language is widely used on the web, and is often confused with JavaScript or JScript, the two major dialects from which ECMAScript was standardized.

Metadata

Metadata (meta data, or sometimes metainformation) is “data about data” of any sort in any media. An item of metadata may describe an individual datum, or content item, or a collection of data including multiple content items and hierarchical levels, for example a database schema. In data processing, metadata is definitional data that provides information about or documentation of other data managed within an application or environment.

For example, metadata would be document data about data elements or attributes: name, size, data type, et cetera; data about records or data structures: length, fields, columns, et cetera; and data about data: where the data is located, how the data is associated, ownership, et cetera. Metadata may include descriptive information about the context, quality and condition, or characteristics of the data. Thus, metadata provides context for data.

Metadata is used to facilitate the understanding, characteristics, and management usage of data. The metadata required for effective data management varies with the type of data and context of use. In a library, where the data is the content of the titles stocked, metadata about a title would typically include a description of the content, the author, the publication date and the physical location.

Program Metadata

Metadata is casually used to describe the controlling data used in software architectures that are more abstract or configurable. Most executable file formats include what may be termed “metadata” that specifies certain, usually configurable, behavioral runtime characteristics.

In Java, the class file format contains metadata used by the Java compiler and the Java virtual machine to dynamically link classes and to support reflection. The J2SE 5.0 version of Java included a metadata facility to allow additional annotations that are used by development tools.

“Source code” describes the text which is translated by a compiler into executable software applications. Metadata may be intended as secondary instructions for a compiler, or to be read by software developers.

The concept of “inheritance” is at the core of modern software development. For example:

Mammal [symbol] Pet [symbol] Cat

The “Cat” Class has inherited all the functionality embedded in the parent class “Pet”, which in turn inherits the functionality of class “Mammal”.

While software compilers allow for complex and well-defined inheritance patterns for the functionality of classes, the compilers do not allow for the inheritance of metadata. In the case of the above example, metadata is defined for Method A of class “Mammal”, and also defined for Method A of class “Pet”. According to the prior art, the software compiler only displays the metadata assigned to Method A of class “Pet”. One embodiment of the invention allows the software application to examine the internal structure of classes, their chains of inheritance, and generate a composite Metadata profile at runtime. This Metadata Profile exposes metadata assigned in all inherited Classes to the final Class in the inheritance chain.

PNG Files

Portable Network Graphics (PNG) is a bitmapped image format that employs lossless data compression. PNG supports palette-based (palettes of 24-bit RGB colors), greyscale or red, green, and blue (RGB) images. PNG was designed for transferring images on the Internet, not professional graphics, and so does not support other color spaces (such as cyan, magenta, yellow, and key black (CMYK)). A PNG file is a compressed bitmap, therefore each pixel has a certain length. With a 3×3 pixel image, the pixels are sequentially placed right after each other and look like the following: [1,1][2,1][3,1][1,2][2,2][3,2][1,3][2,3][3,3] with [x,y] being a pixel of a fixed byte length, dependent on the palette size and other options. Because of the fixed byte length of each pixel, calculation of the memory address of a specific pixel is rapid.

Adobe Flex

Adobe Flex is a collection of technologies released by Adobe Systems for the development and deployment of cross platform rich Internet applications based on the proprietary Adobe Flash platform. In February 2008, Adobe released the Flex 3 SDK under the open source Mozilla Public License. Adobe Flash Player, the runtime on which Flex applications are viewed, and Adobe Flex Builder, the IDE built on the open source Eclipse platform and used to build Flex applications, remain proprietary.

PureMVC

PureMVC is a lightweight framework for creating applications based upon the classic Model, View and Controller concept. Based upon proven design patterns, this free, open source framework which was originally implemented in the ActionScript 3 language for use with Adobe Flex, Flash and AIR, has now been ported to nearly all major development platforms.

Shell

In computing, a shell is a piece of software that provides an interface for users. The name ‘shell’ originates from shells being an outer layer of interface between the user and the innards of the operating system (the kernel). Typically, the term refers to an operating system shell which provides access to the services of a kernel. However, the term is also applied very loosely to applications and may include any software that is “built around” a particular component, such as web browsers and email clients that are “shells” for HTML rendering engines.

Operating system shells generally fall into one of two categories: command line and graphical. Command line shells provide a command line interface (CLI) to the operating system, while graphical shells provide a graphical user interface (GUI). In either category, while the primary purpose of the shell is to invoke or “launch” another program, shells frequently have additional capabilities such as viewing the contents of directories.

### BRIEF DESCRIPTION OF THE DRAWINGS

FIG. 1 is a flowchart depicting the Network Browser during runtime,

FIG. 2 depicts the grouping and order of layers in the Network Browser,

FIGS. 3-17 are screenshots of the screen appearance when zooming out in a space, turning the space into an icon, further spaces and connections appearing and the zooming into another space,

FIGS. 18-22 are depictions of transformations between content and context,

FIG. 23 illustrates processes and mechanisms of the MetadataUtil,

FIG. 24 is a high level functional block diagram of an embodiment,

FIG. 25 is a block diagram of a computer system hardware useable in conjunction with an embodiment of the browser, and

FIG. 26 is a high level metadata process flow according to an embodiment.

### DETAILED DESCRIPTION

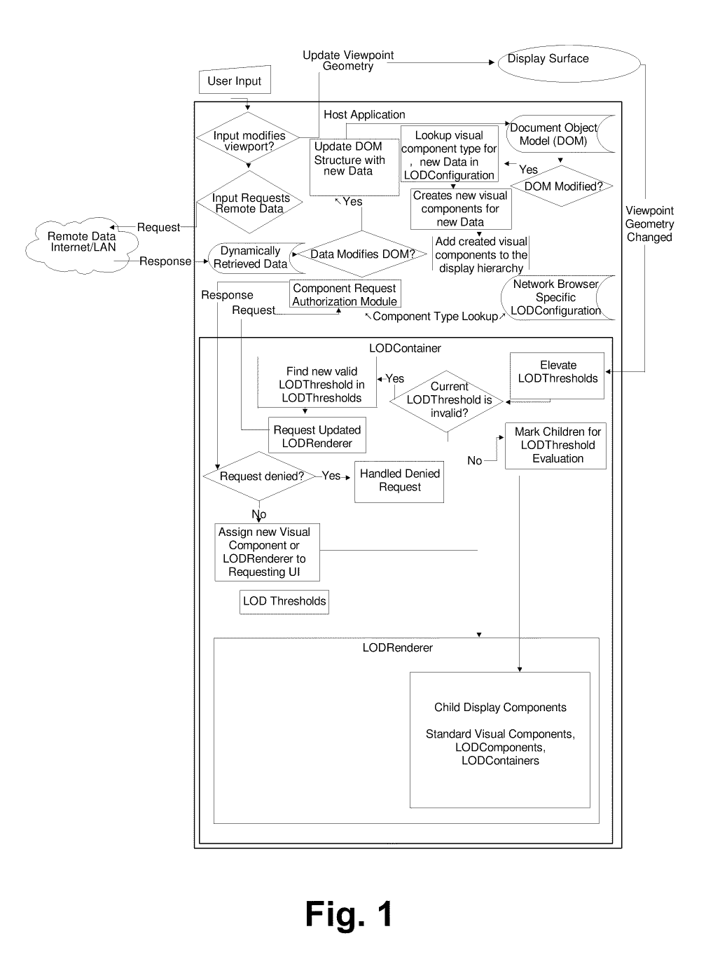

A Network Browser is an implementation of a Level of Detail (LoD) System, configured by the loading and reading of XML documents, and explicitly coded associations between data types and visual display components. These bindings of data types and visual components associate the data that represents users, user relationships, user content, user metadata, and search results to specific visual components via an LODConfiguration object. The Network Browser also modifies the visibility and geometric properties of the visual components to reflect the sorting, filtering, and/or navigation settings of the current user. FIG. 1, a flow chart of the Network Browser process flow at runtime, illustrates the relationships between processes and objects that process user input, those processes being to manipulate the display surface, render and update the current document, and authorize visual component requests. Illustrated also by FIG. 1 is the Level of Detail subsystem which allows the Network Browser to render data with multiple types of visual component, selecting the component best suited to the current zoom level and dimension of the document viewport.

These associations allow the Network Browser to create a specific visual component to represent each result of a user query, assign the data to the visual component, and place the resulting configured visual component on screen, i.e., displayed on a monitor or other display device responsive to a processor, by the Network Browser, where it may be arranged into a specific layout via user interaction through an input device.

Since the Network Browser programatically extends the LoD system used to render DOM objects, the Network Browser can render any extant space, as well as the relevant relationships, associated data and/or metadata. This allows the user to seamlessly move from a low resolution view of their account, contacts, created spaces, content, and/or other associated data (represented as icons or schematics), to a detailed view comprising interactive controls for manipulation of the data.

The Network Browser is configurable by developers in that it allows the assignment of a LODConfiguration (2411) object to the LODContainer (709) which will notify child LODComponents (709) of their current visual dimensions.

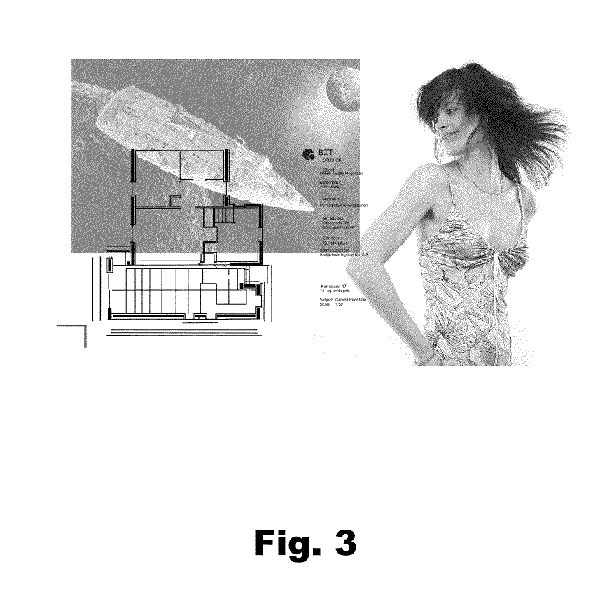

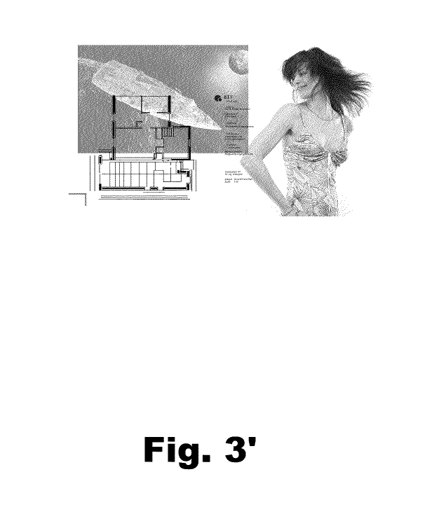

For instance, at the most distant view, a single graphic might represent the overall account information of the user. In FIG. 3, a single Space is displayed in the Browser. The Network Browser has rendered the DOM by placing a hierarchy of visual components on screen, applied their geometric properties, and adjusted the viewport to display a specific view of the Space. As the user zooms in, this image is then replaced by multiple graphics, each representing groups of data organized into clusters or hierarchies. Further zooming results in the user being presented with an actual space they have created, a form, or other UI.

In order for the Network Browser to support this level of flexibility, a comprehensive LODConfiguration (2411) is defined. The LODConfiguration (2411) defines renderers (LODRenderers) (708) and thresholds (LODThresholds) (706) for each type of data that the system supports. The LODThreshold (706) represents a geometric criteria, defined by a minimum and maximum Rectangle. The LODThreshold (706) can store the minimum and maximum criteria for surface area, aspect ratio, width, and height for UI components on screen.

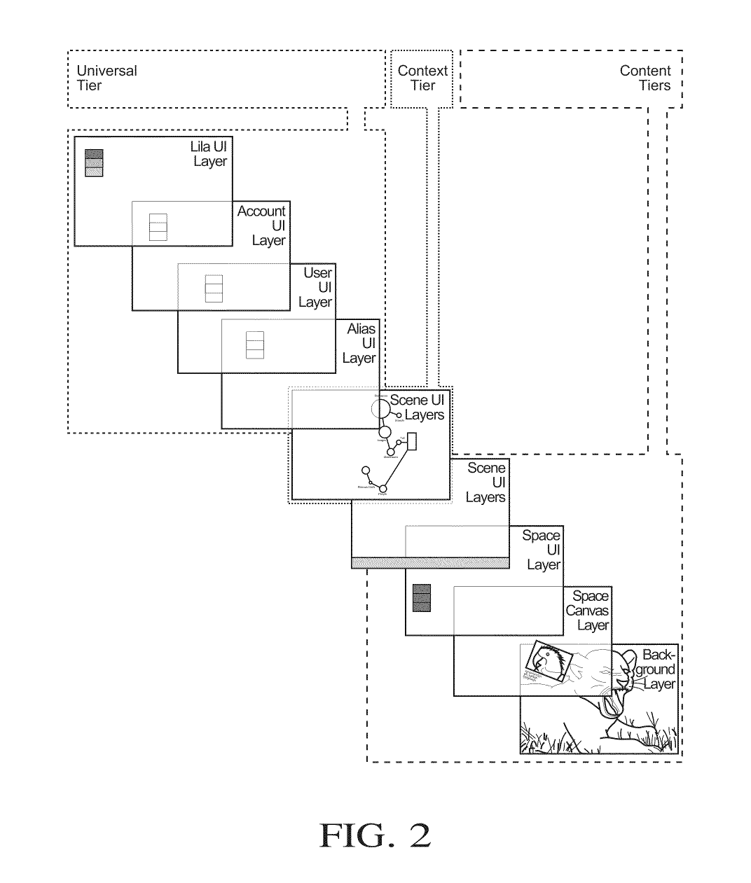

1. FIG. 2 describes the ordering in which each virtual display Layer within the Network Browser is composited onto the preceding Layers.
These Layers are grouped into three overall categories, which are:
The Universal Tier, which contains visual user interface components that make up the Application UI, such as Tool Palettes and Menus, visual user interface components that represent the status of the current User Account, and visual user interface components shown as a result of user interaction. The Universal Tier contains four specific Layers:
   The Lila UI Layer, used for Application visual user interface components.
   The Account UI Layer, used to display visual user interface components related to the currently active user account.
   The User UI Layer, which contains visual user interface components placed on screen as the result of user interaction with menus and tools.
   The Alias UI Layer which contains visual user interface components placed on screen by user interaction with interactive visual components within the currently displayed document.
The Scenes Tier, which contains the visual user interface components that define the user specified scenes within the current document. Manipulating these components allows the user to precisely control what areas of their document are displayed at each step in the default presentation.
The Content Tiers, which contain all visual user interface components, and content that the user has added to their document, such as images, audio, video, text, and multimedia. The Content Tiers group contains four specific Layers:
   The Scene UI Layer, which displays visual user interface components defined by the user for display when the Network Browser has been navigated to a specific Scene.
   The Space UI Layer, which displays visual user interface components defined by the user for display when the Network Browser is navigated anywhere within the document.
   The Space Canvas Layer, which contains all content that the user has added to their document, such as images, audio, video, text, and multimedia.

The Background Layer, which contains a separate layer of content that the user has added to their document, such as images, audio, video, text, and multimedia, but which is always kept behind the content placed in the Space Canvas Layer.

In order for the Network Browser to allow the user to zoom into any of these objects, the Network Browser retrieves the data for clusters, DOMs, and large data sets on demand (2404). This means that, in a particular configuration, the Network Browser renders a list of twenty available documents and displays their preview images. When the user crosses a LODThreshold (706) and has zoomed close enough to a specific object, the data required to render its children is retrieved and the required user interface (UI) is displayed on a display. In other words, when the minimum Level of Detail for the space is reached, as determined by the evaluation of LODThreshold objects defined in the LODConfiguration of the topmost document object, the space client automatically transitions from displaying the content of a single space, to displaying the Network Browser in such a way where the Network Browser view is centered on a representation of the space whose minimal Level of Detail has been reached, and is surrounded by visual components representing spaces, content, and users who are available to the current user of the Network Browser. The LODThreshold (706) is crossed when the associated visual components' on screen geometry no longer falls within the range of width, height, aspect ratio or surface area defined by the properties of the associated LODThreshold (706) object.

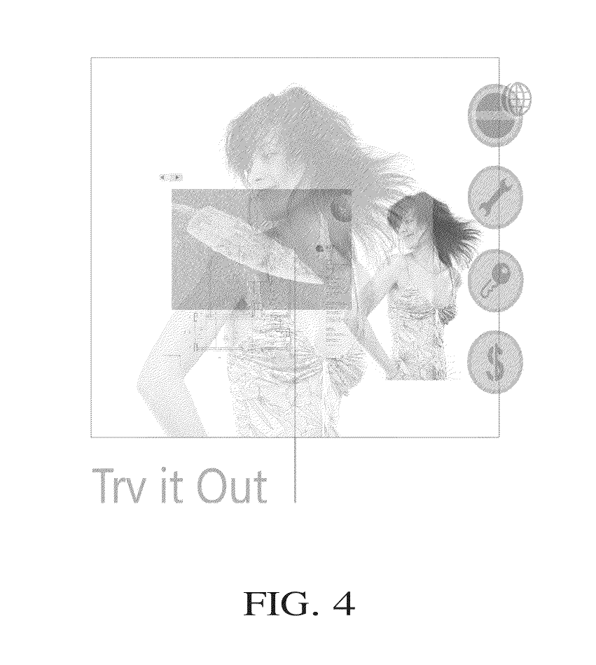

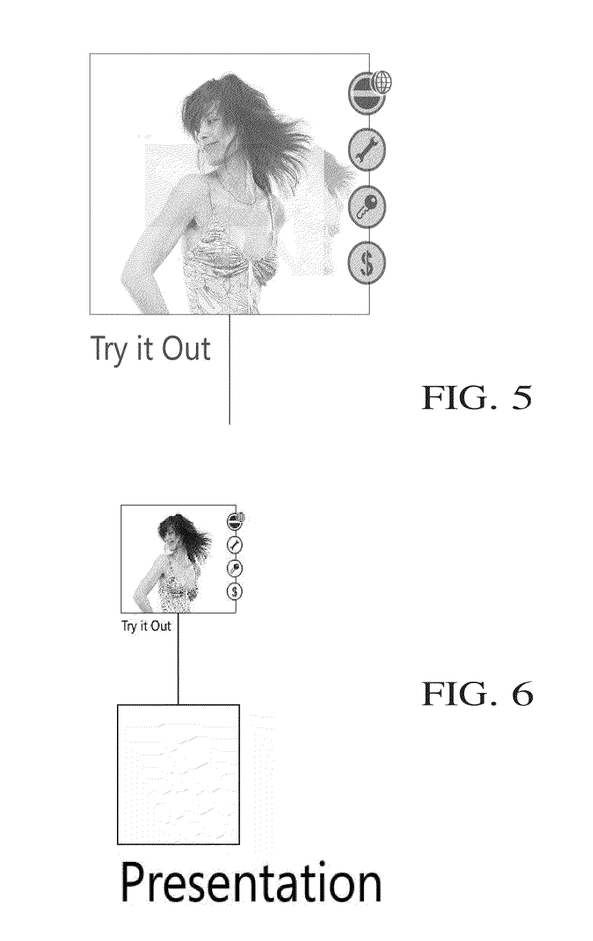

In FIG. 3′, the user has zoomed the viewport out by manipulation of an input device, thus reducing the display size of the rendered document. The reduction in size has not invalidated the Level of Detail of any of the visual components. In FIG. 4, the user has zoomed the viewport out by manipulation of an input device, thus reducing the display size of the rendered document. The reduction in size has invalidated the Level of Detail of the visual components, and the figure illustrates the crossfading transition at a halfway point between the old and new visual components. In FIG. 5, the crossfading transition has completed, and the Space is now displayed on screen using the new visual components that were assigned when the Level of Detail was changed as a result of user manipulation of the viewport. In FIG. 6, the user has panned the viewport by manipulation of an input device in order to view content which was not previously visible.

The user manipulates an input device such as a mouse and/or keyboard to input information to the Network Browser related to layout templates and/or filter criteria (2405) allowing exploration of large amounts of data, or explicitly layout the contents of the Network Browser, allowing the user to quickly organize and refine the visual representation of the data.

An application according to an embodiment connects to a data store, e.g., on a remote server, LAN, or local storage (2403). The data store stores information for user accounts, relationships, content, documents, and/or metadata related to the application.

After authentication, the application retrieves data related to the user and requested document (DOM) and media.

The application then assembles the returned DOM into a visual display (2416) that is modifiable by the user, either through direct geometric manipulation of objects, or the assignment of new property values via input fields and controls.

The assembled DOM is translated into a collection of virtual layers, which make use of the Level of Detail (LOD) system to discover the correct visual representations of the data based on the current level of zoom and display size of the document.

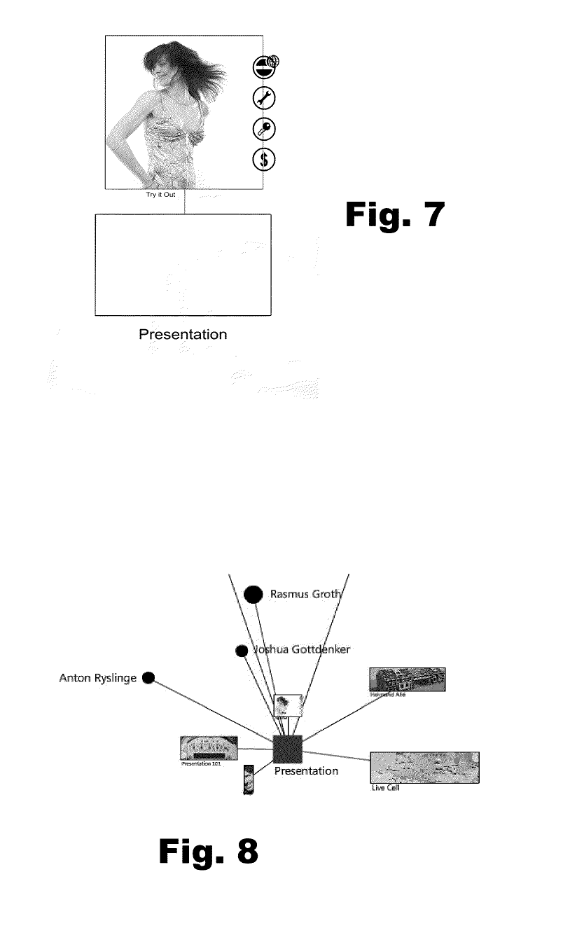

In FIG. 7, the user has zoomed the viewport out by manipulation of an input device. The change in zoom level has begun a transition to a new level of detail, but not yet updated the screen. At this reduced zoom level, the Network Browser requests all remotely or locally stored information that relates to the top level element in the current Document Object Model.

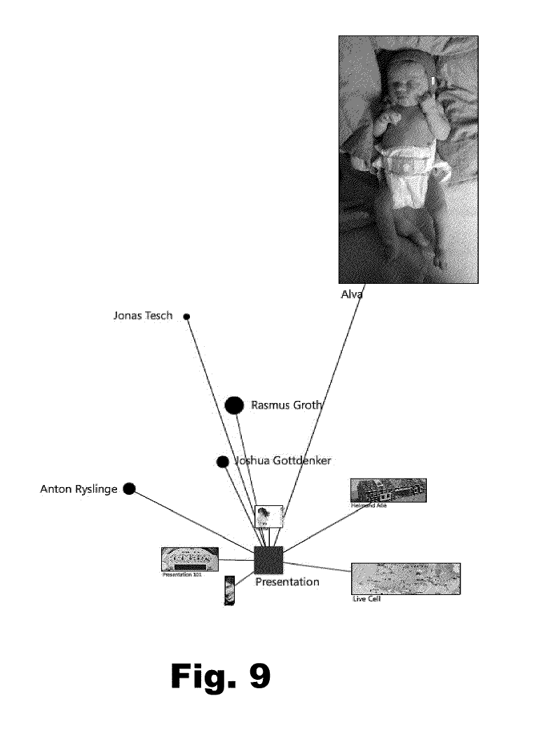

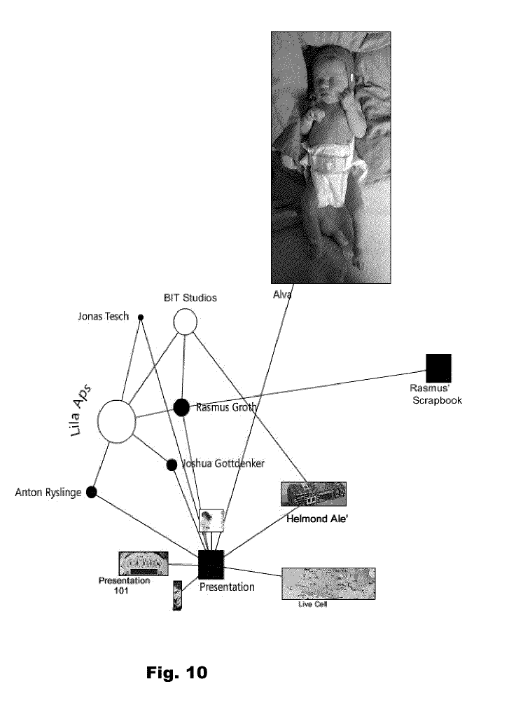

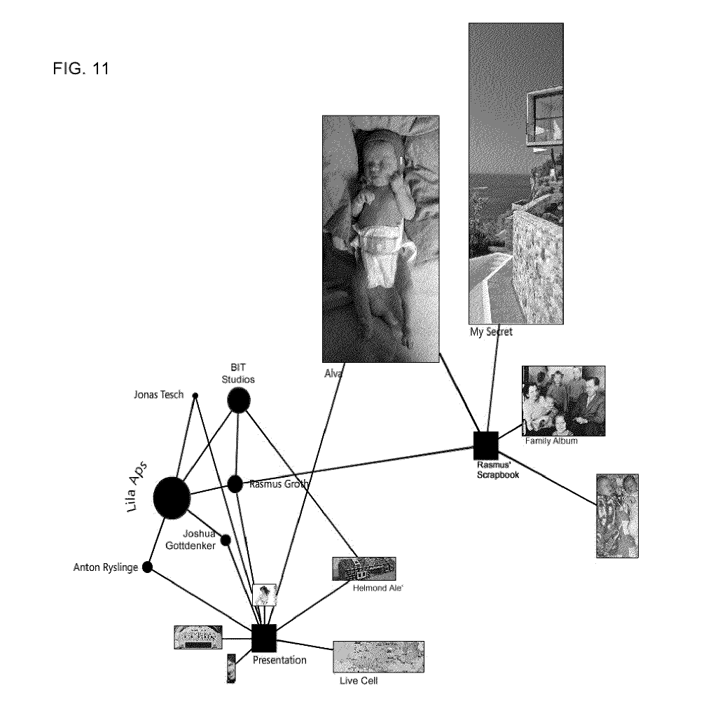

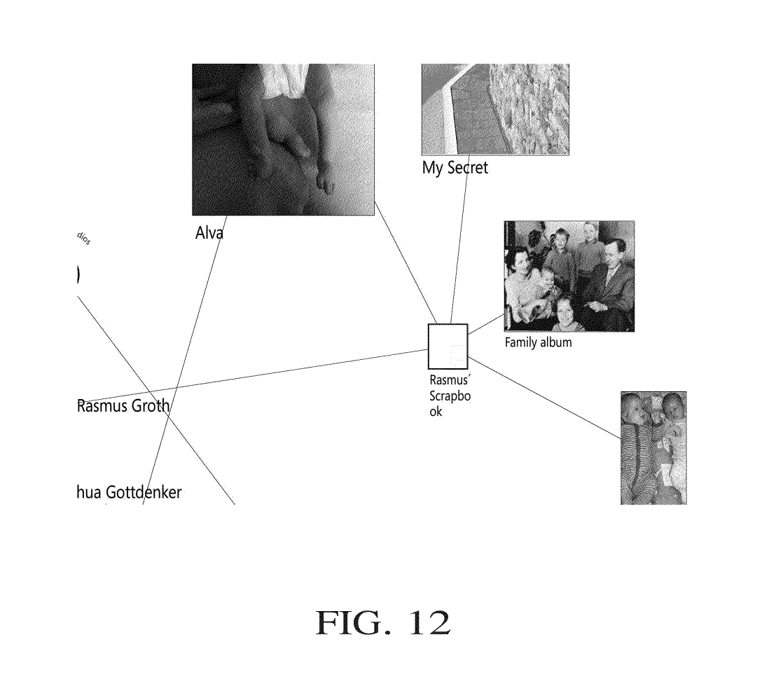

In FIG. 8, the data requested in FIG. 7 has been retrieved, visual components for each new data element have been created, and the data assigned to the visual components. The relationships between the displayed nodes is visualized by connecting lines between the nodes. In FIG. 9, the user has panned the viewport up, and zoomed out by manipulating an input device. Previously offscreen content is now visible, and the Level of Detail has changed. At this reduced zoom level, the Network Browser requests all remotely or locally stored data that relates to the currently displayed content. In FIG. 10, the data requested in FIG. 11 has been retrieved, visual components for each new data element have been created, and the data assigned to the visual components. The relationships between the displayed nodes is visualised by connecting lines between the nodes. In at least some embodiments, the application connects to a Multiuser server (2402), and establishes connections to other authorized users (2401) who are manipulating the same document. Each user has a local copy of the document (DOM)(2409). Changes to that document are mediated by the Multiuser Server (2402), so that conflicting changes are denied, and accepted changes are propagated to each User connected to the Multiuser server. Users establish ownership of DOM nodes by clicking on their visual representations. DOM nodes that are owned by a user may not be manipulated by other users connected to the same document.

Users modify the properties of DOM nodes, collect DOM nodes into groups, break groups, create new nodes by adding new media or data to the DOM, or remove nodes by deleting them from the DOM. Changes to the DOM are communicated to other users via the Multiuser server (2402) in order to synchronize the data and visual representation of the DOM throughout the editing session.

The application is compiled to one or more binary or bytecode formats, such as Flash Player .swf files, Microsoft Silverlight libraries, or Adobe AIR desktop applications. The application is then accessed by navigating to a URL where the application is instanced and executed by the browser, or executed by activating an installed desktop application.

An Example of Network Browser Usage:

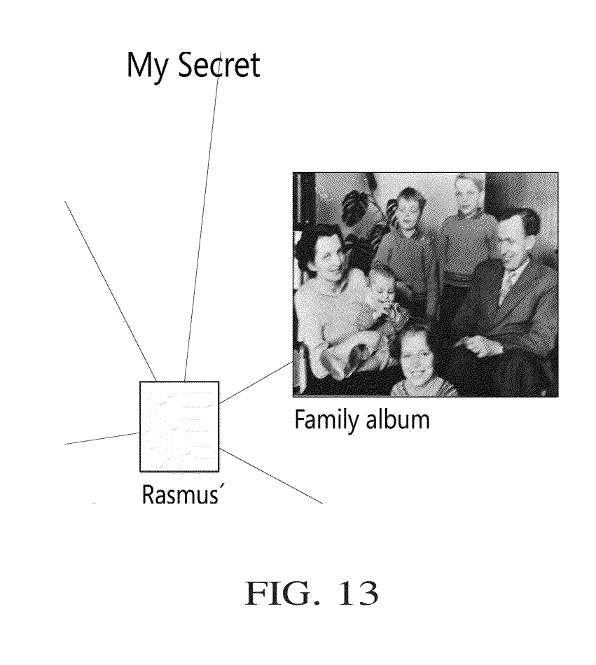

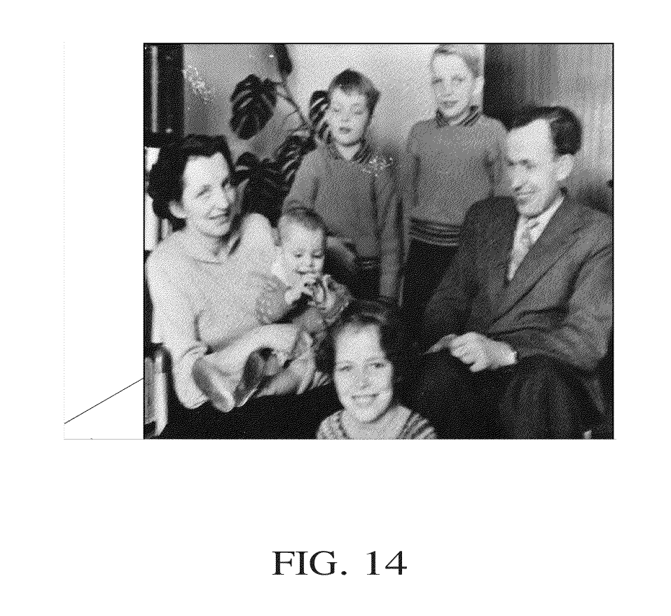

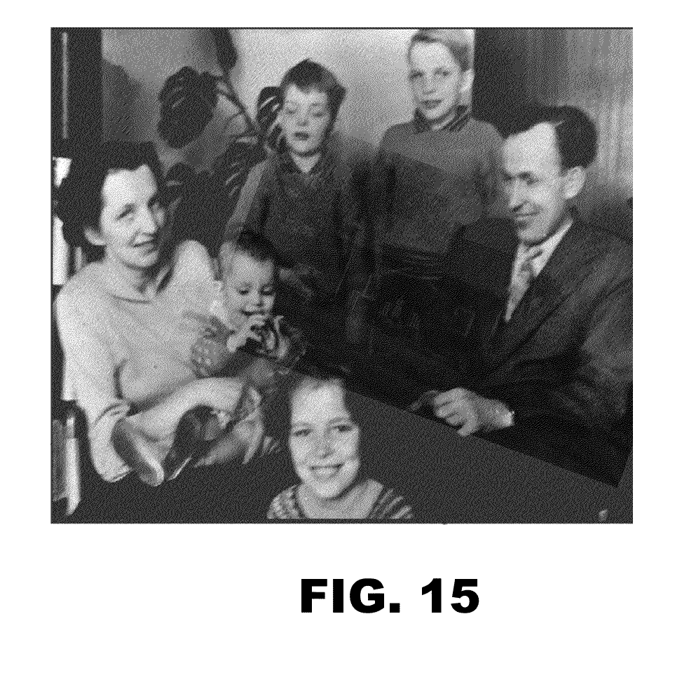

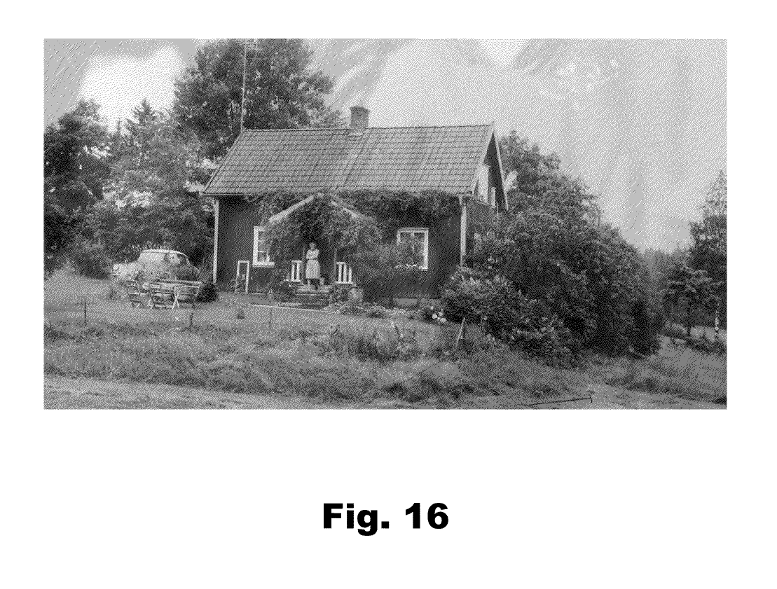

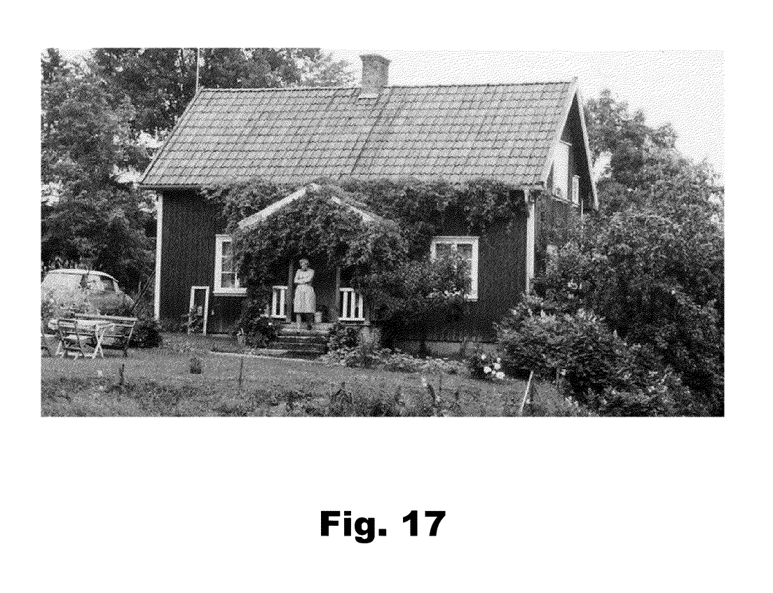

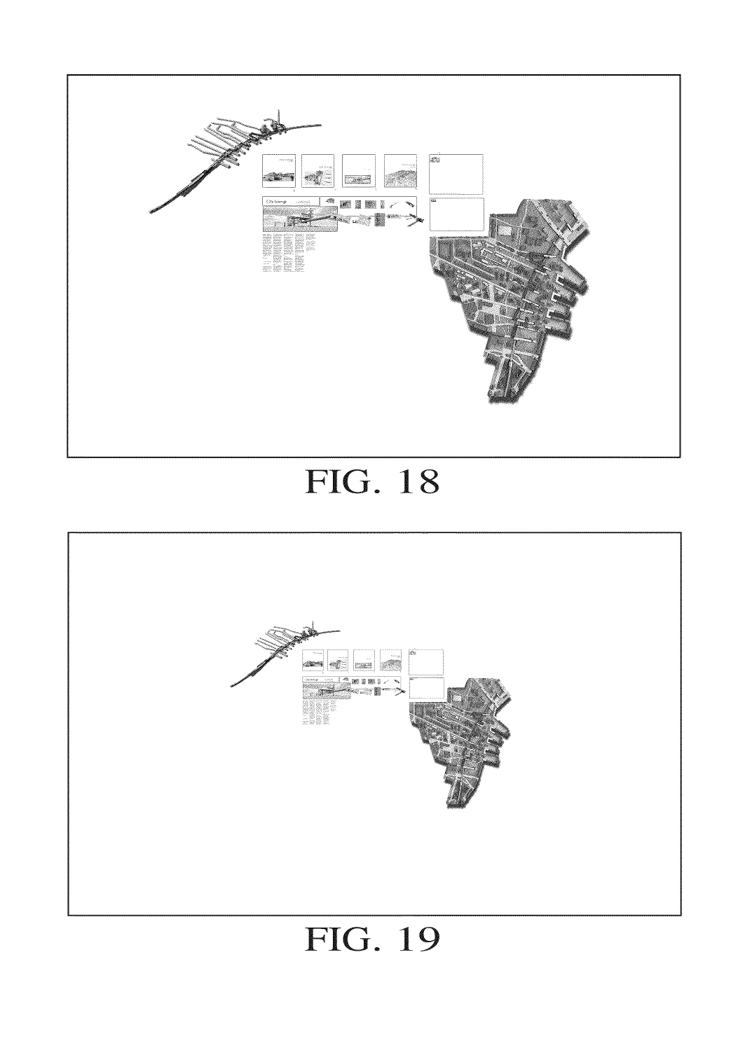

The following describes a process wherein a user uses the Network Browser to view information representing the user and associated content, searches for new content, views content in the search result, and then examines their personal User Account information.
1. Network Browser loads user data from remote or local storage media.
2. Network Browser displays user information, and thumbnails representing contacts, content, and spaces owned by or directly available to the user.
3. User queries (2405) for spaces with metadata that matches a search string.
4. Network Browser, based on the received user query, retrieves result from server. In FIG. 10, the user has interacted with the node onscreen labeled “Rasmus' Scrapbook”, either clicking it with an input device, or selecting with a pointing device and pressing the Enter key. Data related to this node has been retrieved, visual components for each new data element have been created, and the data assigned to the visual components. The relationships between the displayed nodes is visualized by connecting lines between the nodes. The Network Browser arranges the resulting visual components which represent the data into a grid or other algorithmically defined layout. The Network Browser then places these objects into unoccupied space in the Network Browser canvas on screen.
5. The user manipulates the display by zooming, panning, or rotating the displayed information using a user input device.
6. The top level LODContainer (704) communicates the user-generated geometric changes to the tree (709) of LODComponents, which evaluate the new displayed dimensions. If the changes are such that a LODComponent (709) must transition to a new level of detail, i.e. a threshold value has been met, the LODComponent (709) emits a request via an Event and Listener pattern of communication supplied by the underlying programming language in which the LoD library is implemented.
7. In FIG. 12, the user has zoomed the viewport in by manipulation of an input device, thus reducing the display size of the rendered document. The increase in display size has invalidated the required resolution of the visual components rendering bitmap image data on screen. The visual components have requested new bitmap image data, retrieved the data, and are now displaying the same images at a level of resolution appropriate for the zoom level. Visual components that are rendering bitmap information, but are not visible have been set to a minimum Level of Detail. In FIG. 13, the user has panned and zoomed the viewport by manipulation of an input device, in order to center the view on the visual component labelled “Family Album”. The increase in display size has invalidated the required resolution of the visual components rendering bitmap image data on screen. The visual components have requested new bitmap image data, retrieved the data, and are now displaying the same images at a level of resolution appropriate for the zoom level. Visual components that are rendering bitmap information, but are no visible have been set to a minimum Level of Detail. In FIG. 14, the user continues zooming into the visual component labelled “Family Album”. The increase in display size has invalidated the required resolution of the visual components rendering bitmap image data on screen. The visual components have requested new bitmap image data, retrieved the data, and are now displaying the same images at a level of resolution appropriate for the zoom level. Visual components that are rendering bitmap information, but are not visible have been set to a minimum Level of Detail. In FIG. 15, the user has zoomed the viewport in by manipulation of an input device, thus increasing the display size of the rendered document. The increase in size has invalidated the Level of Detail of the visual components. This figure illustrates the crossfading transition to the new Level of Detail at a halfway point between the old and new visual components.
8. In FIG. 16, the user has continued the zoom operation begun in FIG. 15, continuing to increase the display size of the rendered document, and again invalidated the current Level of Detail. This figure illustrates the crossfading transition to the new Level of Detail at a halfway point between the old and new visual components. In FIG. 17, the crossfading transition begun in FIG. 14, and updated in FIGS. 15 and 16, has completed, and the visual components are correctly represented at the new Level of Detail.
9. Upon receiving a response to the request made in step 7, the LODComponent (709) representing the search result data places the new visual component on screen, and removes the old visual component from the screen.
10. The new visual component then requests the entire DOM of the space referenced by the search result data.
11. The data describing the DOM is returned from local or remote storage to the Host Application (702), which in turn assigns the data to the requesting LODComponent (709). The LODComponent (709) requests new LODComponents (709) and LODRenderers (708) for each element in the data. As each LODComponent (702) of LODRenderer (709) is returned by the Host Application response to requests for LODComponents (709) and LODRenderers (708), the corresponding data element is assigned to the supplied LODComponent (709) or LODRenderer (708), which is then placed on screen.
12. The user has now seamlessly transitioned from an overall network view of their content, to a view of a specific DOM.
13. The user then zooms out by sending one or more commands to the Host Application by manipulation of the keyboard, mouse button or buttons, mouse wheel, trackpad, touchscreen, or other connected input devices. Such commands are interpreted (2406) by the Host Application (702), and result in logical manipulation of the viewport on screen by either zooming, panning, rotating, or otherwise modifying the viewport.
14. The LODComponent (709) rendering the DOM transitions to a lower level of detail. Child objects of the LODComponent (709) are moved off screen and/or are destroyed.
15. The user then zooms into an icon representing their account information.
16. The LODComponent (709) representing the account verifies that the current user is the owner of the account referenced by the account information icon, and moves to the next level of detail.
17. The new level of detail is represented by a Form component that renders the associated user account information, validates changes made by the User, and/or saves changes back to the server.
18. Demonstrating the zooming out functionality are FIGS. 18 through 22. FIG. 18 shows the Space Canvas Layer of the Network Browser, at a specific zoom level of a Space. In FIG. 19, the user has zoomed the viewport out by manipulation of an input device, thus reducing the display size of the rendered document. The reduction in size has not invalidated the Level of Detail of any of the visual components.

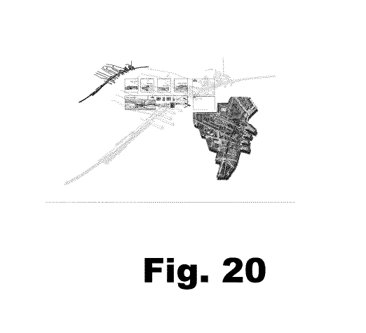

In FIG. 20, the user has zoomed the viewport out by manipulation of an input device, thus reducing the display size of the rendered document. The reduction in size has changed the Level of Detail of displayed the visual components so that the previously visible content has been removed from the screen, and the previously hidden container of the content is displayed at a minimal Level of Detail which shows a bitmap preview of its' contained content.

At this reduced zoom level, the Network Browser requests all remotely or locally stored information that relates to the top level element in the current Document Object Model.

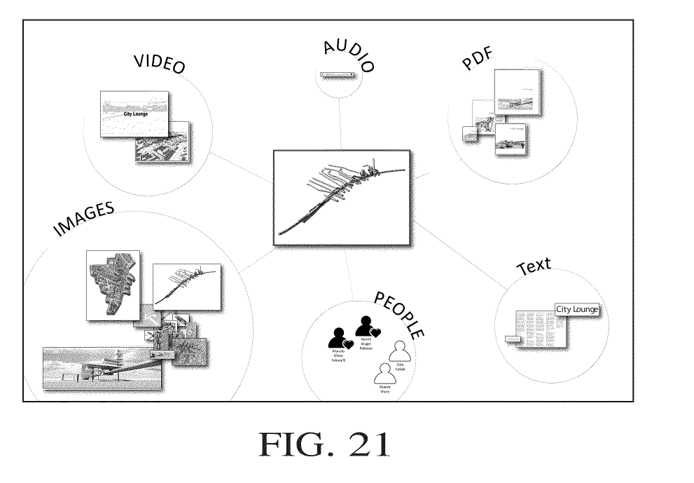

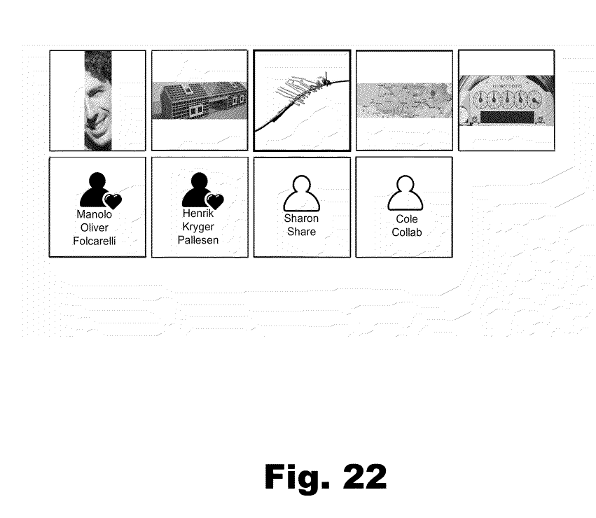

In FIG. 21, the data requested in FIG. 20 has been retrieved, visual components for each new data element have been created, and the data assigned to the visual components. The relationships between the displayed nodes is visualised by connecting lines between the nodes. In FIG. 22, the user has zoomed the viewport out by manipulation of an input device, thus reducing the display size of the rendered document. The reduction in size has changed the Level of Detail of displayed the visual components so that the previously visible content has been removed from the screen. At the current Level of Detail, an overview of Users and Media related to the document is displayed for review.

Metadata Inheritance

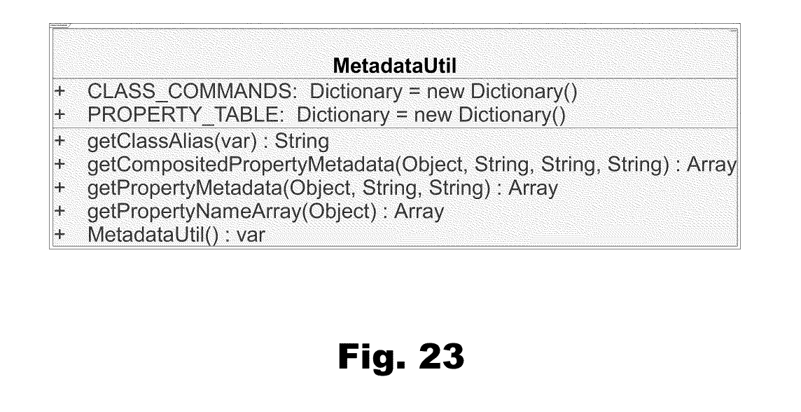

FIG. 23, “MetadataUtil,” illustrates the logical processes and internal caching mechanism of the MetadataUtil.

Regarding Metadata

In Actionscript and related languages (e.g., ECMAScript 4 & 5), metadata is represented by the association of keys and values to a metadata type identifier, so that in the following example

[LilaProperties(default=“2”, type=“int”,
enum=“0,1,2”,id=“Allow_Download”)]
public var allowDownload:String;

the metadata definition above defines the Allow_Download property, which is an integer, with a default value of 2, and a set of possible values of 0, 1, or 2. In this case, the phrase LilaProperties is the metadata type identifier, which can be used to group or select metadata definitions of similar types.

Classes may inherit from multiple superclasses, so that methods and variables defined in subclasses supersede the definitions of methods and variables in their superclasses.

However, these languages provide no inherent method for metadata to be overridden by metadata defined in subclasses in the same manner that methods and variables are overridden. This functionality is provided by the logic implemented in the MetadataUtil class.

The MetadataUtil Implementation

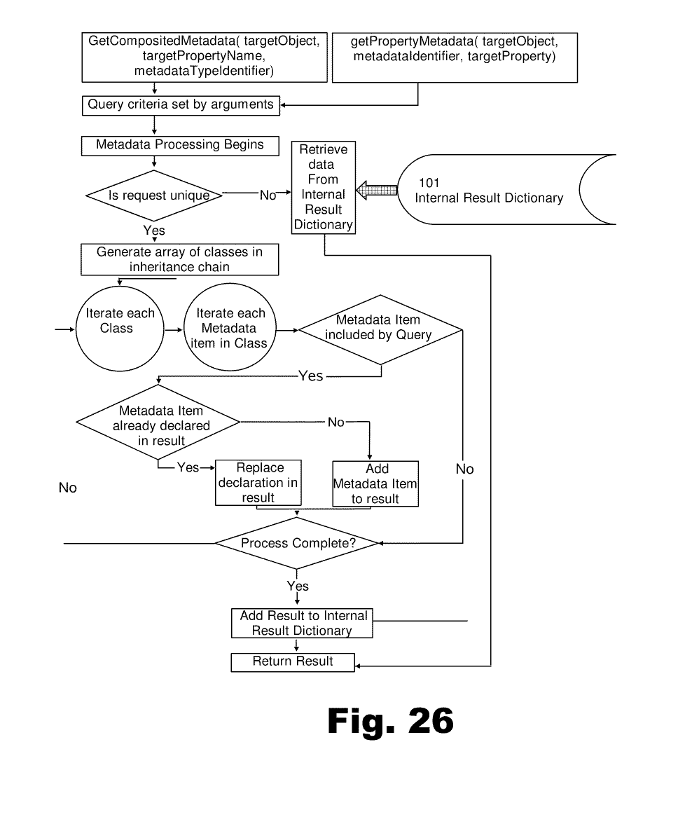

The MetadataUtil class implements the following logic, as shown in FIG. 26 in order to provide a composite profile of metadata which has been assigned to a class which inherits from one or more superclasses.
The MetadataUtil inspects objects supplied and generates a table of generic Objects which contain the key/value pairs contained within each Metadata entry associated with an object of a specific Class, wherein metadata defined in subclasses supersedes definitions made with identical identifiers in superclasses.
The MetadataUtil caches the results of queries in Dictionary objects, which are stored within a top level Dictionary object that contains the results for each unique request made to the MetadataIUtil. Once a request is processed and stored in the Dictionaries, the MetadataUtil responds to further queries for the same data by returning the data stored in the internal Dictionary objects.
The MetadataUtil allows queries to specify Metadata type selectors which are used to enable the generation of metadata for all or some properties of a class, as well as selectors to limit the generation of metadata to some or all types of metadata as defined by a list of metadata identifiers provided to the MetadataUtil. These selectors are evaluated during the iteration over all metadata contained by the target class, and are used to determine whether or each metadata element falls within the limits of the query.

### Example

MetadataUtil.getPropertyMetadata(objectToExamine,“allowDownload”, “LilaProperties”);

The line above returns an array of objects representing individual metadata definitions of type “LilaProperties” that are associated with the variable named “allowDownload” which is defined in the class of which objectToExamine is an instance.

Each item in the returned array contains the key/value pairs defined for that metadata declaration. When a definition in a subclass has the same id as a definition in the superclass, the definition provided by the superclass is removed from the resulting data.

This occlusion of inherited metadata allows a novel structural parity of variables, methods, and metadata in inheriting classes.

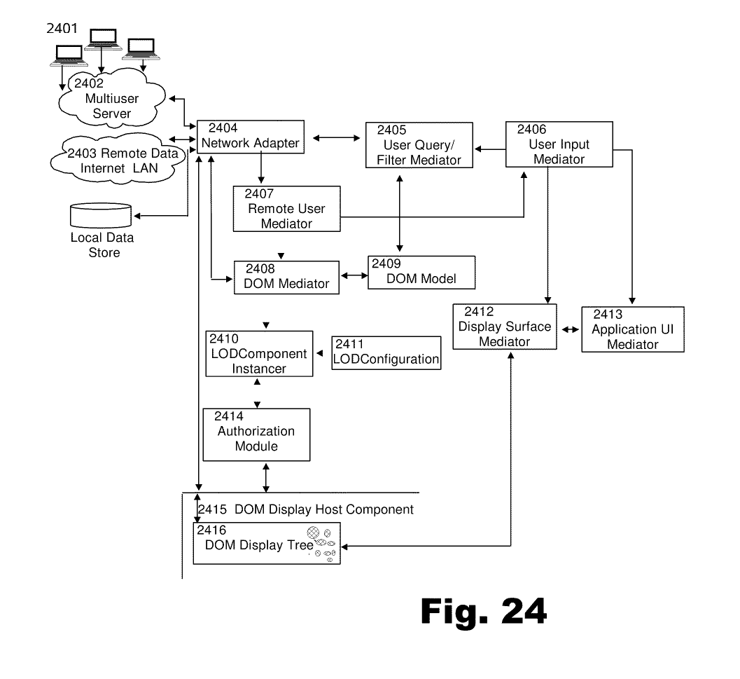

FIG. 24 is a high-level functional process flow. In this figure, a high level flowchart of the Network Browser system architecture is presented. Blocks describing Mediators refer to units of logical code that receive input from other parts of the application, and based on internal logic, forward information to other modules or outputs of the application. This chart describes the following objects:

### 2401: Remote Users Connected to the Multiuser Server

Remote Users manipulate the same document simultaneously by receiving permission to modify DOM nodes from the Multiuser Server, synchronising their changes with other Users.

### 2402: The Multiuser Server

One or more server which accept connections from Users, and administer permissions and data synchronisation between Users.

### 2403: A Remote Datasource

A source of data located on an external machine, LAN, website or webservice.

### 2404: The Network Adapter

A module which receives requests for information from other modules within the Network Browser, and manages the retrieval and return of said data.

### 2405: User Query/Filter Mediator

A module which applies filter to the currently loaded DOM, and requests and applies the results of queries to either the local DOM or remote data by the User.

### 2406: User Input Mediator

The User Input Mediator receives input generated by the manipulation of input devices, and translates said input into messages which cause action to be taken within the application.

### 2407: Remote User Mediator

The Remote User Mediator is receives changes to the local document made by Remote Users, and notifies the DOM Mediator and User Input Mediator of their arrival.

### 2408: DOM Mediator

The DOM Mediator receives messages related to modifications of the DOM, manages their application based on internal logic, and causes modification to the visual components which represent the DOM to be made.

### 2409: DOM Model

The data structure which describes a Document.

### 2410: LODComponent Instancer

The LODComponent Instancer is a module used by the Authorisation Module to create the UI Components requested by children of the Dom Display Tree.

### 2411: LODConfiguration

The LODConfiguration is the data structure assigned by developers which maps UI Components to specific levels of detail.

### 2412: Display Surface Mediator

The Display Surface Mediator receives and emits messages related to the control and updating of the visual display of the application.

### 2413: Application UI Mediator

The Application UI Mediator emits and receives messages related to the creation, destruction, and updating of UI Components which make up the Application UI.

### 2414: Authorisation Module

The Authorisation Module receives and validates and responds to requests for the creation of UI Components used to represent the DOM

### 2415: DOM Display Host Component

The DOM Display Host Component is a container for the Dom Display Tree.

### 2416: Dom Display Tree

The Dom Display Tree is the hierarchy of visual objects which represent the data stored by the DOM Model.

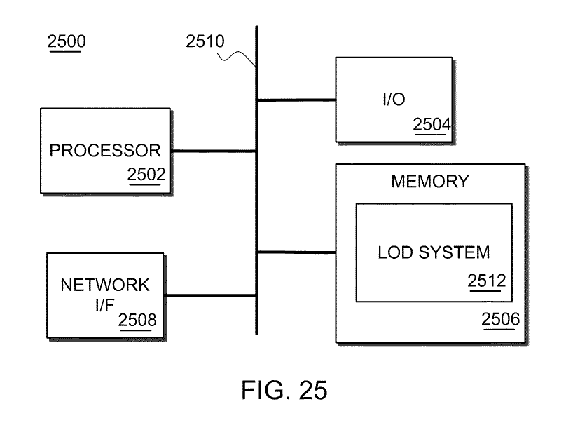

FIG. 25 depicts a high-level functional block diagram of a computer system 2500 usable in conjunction with an embodiment. Computer system 2500 comprises a processor 2502 (alternatively referred to as a processing or controller-based device), a memory 2506, a network interface (I/F) 2508, and an input/output device 2504 communicatively coupled via a bus 2510 or other interconnection communication mechanism.

In at least some embodiments, memory 2506 also stores a set of executable or interpretable instructions, e.g., network browser function 2512, which, when executed or interpreted by the processor, cause the processor to perform a method according to an embodiment of the invention. In at least some embodiments, execution by processor 2502 of the executable instructions causes the display of a user interface to a user of computer system 2500 either via I/O device 2504 or network I/F 2508.

Network I/F 2508 comprises a mechanism for connecting to a network. In at least some embodiments, computer system 2500 comprises more than a single network interface. In at least some embodiments, network I/F 2508 may comprise a wired and/or wireless connection mechanism.

A storage device, such as a magnetic disk, optical disk, or electromagnetic disk, may also be provided and coupled to the bus 2510 for storing data and/or instructions.

Memory 2506 (also referred to as a computer-readable medium) may comprise a random access memory (RAM) or other dynamic storage device, coupled to the bus 2510 for storing data and/or instructions to be executed by processor 2502. Memory 2506 also may be used for storing temporary variables or other intermediate information during execution of instructions to be executed by processor 2502. Memory 2506 may also comprise a read only memory (ROM) or other static storage device coupled to the bus 2510 for storing static information and instructions for the processor 2502.

In at least some embodiments, memory 2506 also stores a set of executable or interpretable instructions, e.g., dynamic zoom/pan function 25012, which, when executed or interpreted by the processor, cause the processor to perform a method according to an embodiment of the invention. In at least some embodiments, execution by processor 2502 of the executable instructions causes the display of a user interface to a user of computer system 2500 either via I/O device 2504 or network I/F 2508.

A storage device, such as a magnetic disk, optical disk, or electromagnetic disk, may also be provided and coupled to the bus 2510 for storing data and/or instructions

Network I/F 2508 comprises a mechanism for connecting to a network. In at least some embodiments, computer system 102 comprises more than a single network interface. In at least some embodiments, network I/F 2508 may comprise a wired and/or wireless connection mechanism.

I/O device 2504 may comprise an input device, an output device and/or a combined input/output device for enabling user interaction. An input device may comprise, for example, a keyboard, keypad, mouse, trackball, trackpad, webcam, acceleration sensor, position sensor, drawing tablet, microphone (or other sound inputs), touch sensor, multi-touch sensor, and/or cursor direction keys for communicating information and commands to processor 2502. An output device may comprise, for example, a display, a printer, a voice synthesizer, etc. for communicating information to a user. In at least some embodiments, I/O device 2504 may comprise a serial and/or parallel connection mechanism for enabling the transfer of one or more of files and/or commands. In at least some embodiments, I/O device 2504 is an optional component of computer system 2500.

It will be readily seen by one of ordinary skill in the art that the disclosed embodiments fulfill one or more of the advantages set forth above. After reading the foregoing specification, one of ordinary skill will be able to affect various changes, substitutions of equivalents and various other embodiments as broadly disclosed herein. It is therefore intended that the protection granted hereon be limited only by the definition contained in the appended claims and equivalents thereof.

What is claimed is:

1. A method of managing digital content within a frame, allowing the digital content to be:
browsed within a frame and/or over the internet;
collected, displayed and presented;
viewed, stored and saved; and,
manipulated, moved, edited and arranged;
whereby:
the digital content is encompassed within a plurality of virtual layers of the frame, corresponding to a plurality of zoom levels/depths of the frame;
the frame comprises at least one space, a space being defined as a subset of the frame and comprising at least a part of the digital content;
browsing the digital content is facilitated by a zoom function (in and out) within the frame and at least one space, thereby enlarging, shrinking, and/or rotating the space or spaces and at least a portion of the digital content;
at least a part of the digital content can be added to, edited and/or moved around in the frame or in a space or spaces within a frame, preferably at any zoom level; and,
the space or spaces within a frame are represented by an icon/node on the frame when minimized to a predefined size.

2. A method according to claim 1, wherein at least a part of the digital content can be added to, edited and/or moved around in the frame or in a space or spaces within a frame at any, or at least one zoom level.

3. A method according to claim 1 wherein the zoom level of the frame can be varied substantially from 0 to 100%, such as from 0 to 200%, such as from 0 to 400%, such as from 0 to 7×0%, such as 100000%, or such as from 0 to 1000000%, ad infinitum.

4. A method according to claim 1, wherein zooming inside the frame can be provided by means of a pointing device. X. A method according to claim 4, wherein the center of the zoom is dynamically defined by the location of the pointing device interface in the frame.

6. A method wherein a network browser displays projects and spaces available to a user, ideally displayed as a navigable network of connected nodes/icons.

7. A method wherein the “space client” (i.e., a multi-user software environment) provides access to the frame for a plurality of users to collaboratively share, view and/or modify the content of spaces, projects, and scenes; and also allows for the navigation between spaces, projects and scenes.

8. A method according to claim 7, wherein within a “space client” is an application embedded in a web browser, such as a Flash application or a Silverlight application.

9. A method for providing at least one user interface control within a Graphical User Interface (GUI) at a variety of zoom depth levels by associating each level of detail with a user interface control; and, whereby each user interface control can be resized and/or repositioned to any dimension.

10. A method for providing the association/inheritance of metadata from a plurality of classes, via an examination of the internal structure and the chains of inheritance within the classes, thereby generating a composite metadata profile for the plurality of classes.

11. An article of manufacture comprising a system and apparatus for the managing of digital content within a frame on at least one screen. The digital content may be:
browsed within a frame and/or over the internet;
collected, displayed and presented;
viewed, stored and saved; and,
manipulated, moved, edited and arranged;
wherein:
the digital content is comprised in a plurality of virtual layers of the frame corresponding to a plurality of zoom levels/depths of the frame;
the frame comprises at least one space, a space being a subset of the frame and comprising at least a part of the digital content;
browsing the digital content is provided by zooming in and out inside the frame and at least one space, thereby enlarging and shrinking, respectively, the space or spaces and at least a part of the digital content; and
the space or spaces within a frame are represented by an icon/node on the frame when shrunk to a predefined size.

12. An article of manufacture comprising a system and apparatus according to claim 11, wherein at least a part of the digital content can be added to, edited and/or moved around in the frame or in a space or spaces within a frame, preferably at any zoom level.

13. An article of manufacture comprising a system and apparatus according to claim 12, wherein the zoom level of the frame can be varied substantially from 0 to 100%, such as from 0 to 200%, such as from 0 to 400%, such as from 0 to 7×0%, such as 100000%, or such as from 0 to 1000000%, ad infinitum.

14. An article of manufacture comprising a system and apparatus according to claim 12, wherein zooming inside the frame can be provided by means of a pointing device.
1X<<Randy, not certain what the X is meant to convey. An article of manufacture comprising a system and apparatus according to claim 14, wherein the center of the zoom is dynamically defined by positioning the pointing device interface in the frame.

16. An article of manufacture comprising a system and apparatus wherein a network browser displays projects and spaces available to a user, ideally displayed as a navigable network of connected nodes/icons.

17. An article of manufacture comprising a system and apparatus according to claim 16, wherein within a “space client” is an application embedded in a web browser, such as a Flash application or a Silverlight application.

18. An article of manufacture comprising a system and apparatus for navigating and/or browsing and/or presenting digital content by means of scenes in a frame on at least one screen, wherein a scene is a predefined or user defined subset of the frame.

19. An article of manufacture comprising a system and apparatus according to claim 18, wherein the digital content is comprised in a plurality of virtual layers of the frame corresponding to a plurality of zoom levels of the frame and wherein a scene is provided with predefined or user defined position, rotation and/or zoom level of the frame.

20. An article of manufacture comprising a system and apparatus according to claim 18, wherein the frame is comprised of at least one space, a space being a subset of the frame and comprising at least a part of the digital content.

21. An article of manufacture comprising a system and apparatus according to claim 18, wherein the digital content can be images, movies, text, web pages, URL, graphics, animations, audio, pdf files and/or similar commercial file structures.

22. An article of manufacture comprising a system and apparatus according to claim 21, wherein the digital content is located/stored on the internet, a LAN and/or a local storage medium.
